(19) United States
(12) Patent Application Publication
(10) Pub. No.: US 2026/0309282 A1
(43) Pub. Date: Oct. 8, 2026

(54) CAP FOR PROVIDING A TAMPER EVIDENCE FEATURE

(71) Applicant: ALPLA Werke Alwin Lehner GmbH & Co. KG, Hard (AT)

(72) Inventors: Vagish DIXIT, Hyderabad (IN); Danilo GRIECO, Dornbirn (AT)

(73) Assignee: ALPLA Werke Alwin Lehner GmbH & Co. KG, Hard (AT)

(21) Appl. No.: 19/482,493

(22) PCT Filed: May 10, 2024
(86) PCT No.: PCT/EP2024/062923

§ 371 Date: Nov. 7, 2025

(30) Foreign Application Priority Data
May 10, 2023 (IN) 202311032974
Jul. 25, 2023 (IN) 202311049998

(51) Int. Cl. F17C 13/06

(52) U.S. Cl. CPC F17C 13/06; F17C 2205/0308; F17C 2205/054; F17C 2260/028

(57) ABSTRACT

Disclosed is a cap (20) for providing a tamper evidence feature on a container. The cap (20) has a cover plate (21) and a sheath protruding therefrom (22). A radially inwardly directed protrusion (23) is formed on the sheath (22), for engagement in a safety cap (30) of a gas cylinder. A thin material point (25) is formed on the cap (20) and separates a separating strip (24) from the cap (20).

The present invention relates to cap for providing a tamper evidence feature on a container, especially a gas container, according to the preamble of the independent claims.

Gas containers, in particular for liquefied gas such as propane, typically have a connecting piece which is closed with a closure cap. In order to ensure that the contents from the gas tank cannot be removed in an impermissible manner, it is typically provided to provide the closure cap with a tamper evidence feature. At present, shrunk-on films are used for this. However, these have the disadvantage that they can be expanded and removed, for example, by heating. As a result, it is possible to remove a part of the contents from the gas container and to attach the film again subsequently, in such a manner that a user cannot recognize whether the gas container is still completely filled or not. A customer who will buy a gas container that is no longer completely filled is cheated.

It is the object of the invention to remedy at least one of the disadvantages of the prior art. In particular, a device is to be provided which makes it possible to provide a tamper evidence feature, specifically such that it can no longer be manipulated easily.

This object is solved by the device defined in the independent claims. Further embodiments emerge from the dependent claims.

A device according to the invention is designed as a cap for providing a tamper evidence feature on a container, in particular on a gas container. The cap has a cover plate and a sheath protruding therefrom. A radially inwardly directed protrusion is formed on the sheath, for engagement in a safety cap of a gas cylinder, in particular for engagement under a protrusion projecting radially from the safety cap. A thin material point is formed on the cap and separates a separating strip from the cap.

By forming a material thin spot, a corresponding separating strip can be separated from the cap in a simple manner. In this case, the thin material point is destroyed, in such a manner that it is evident whether the cap has already been removed from the gas cylinder previously or not.

It can be provided that the separating strip divides the cover plate into two halves at least in regions, in particular completely.

In a first embodiment, the separating strip furthermore divides the sheath of the cap preferably into an upper part and a safety ring. The upper part is connected to the cover plate. In the first embodiment, the separating strip extends in particular only in regions over the cover plate.

In a second embodiment, it is provided that a further thin material point is provided around the sheath. Accordingly, in this embodiment, the further thin material point divides the cap into the upper part and the safety ring. In the second embodiment, the separating strip extends in particular completely over the cover plate

In this case, it can be provided that the further thin material point is arranged such that it is arranged spaced apart from the cover plate so that a portion of the sheath remains connected to the cover plate substantially with an uninterrupted wall thickness.

In an analogous manner, provision can be made in the first embodiment for the separating strip to be arranged spaced apart from the cover plate so that a portion of the sheath remains connected to the cover plate substantially with an uninterrupted wall thickness.

In the first embodiment, the separating strip is preferably formed circumferentially on the periphery of the cap and extends at its end over the sheath into the cover plate and opens in a tongue.

If the separating strip is separated from the cap, or the thin material point is broken open, the safety ring can be removed from the upper part and thus from the cap. The former one-piece cap is accordingly divided into two parts.

In the first embodiment, the separating strip is removed from the cover plate for this purpose and unwound along the periphery of the cap.

In the second embodiment, the separating strip is likewise removed from the cover plate and separated from the cap, or the thin material point is broken open and the two halves of the cover plate are gripped. Then the circumferential further thin material point is also broken open.

The upper part or the two halves of the upper part of the cap can be separated from the safety ring and the upper part can thus be removed from the cap. The former one-piece cap is accordingly divided into three parts, namely the safety ring and the two halves of the cover plate.

The protrusion is preferably arranged on the safety ring in all the embodiments.

If the protrusion is arranged on the safety ring, the safety ring remains together with the protrusion after the separation of the separating strip on the safety cap of the gas cylinder or on the gas cylinder itself. In other words, the cap can be removed from the gas cylinder only by destroying the thin material spot, i.e. the separation of the separating strip. A tamper evidence feature is thus ensured and easy to implement.

The protrusion can have an insertion bevel in the direction of the container so that the cap can be snapped onto a safety cap.

A substantially central opening can be arranged on the cover plate. A tongue is preferably arranged within this opening and is connected to the separating strip.

A tongue allows the user to grasp a beginning of the separating strip. By way of example, a finger can be brought under the tongue through the central opening and the tongue can be gripped accordingly. If the user now pulls on the tongue, it removes the separating strip from the cap. The thin material points are broken open. The safety cap of the gas cylinder is therefore accessible on the one hand, and, on the other hand, it is also evident that the gas cylinder has already been opened.

For safety reasons it can be provided that the tongue is connected to the cover plate via two material webs. These material webs are also separated or broken apart during the first opening.

Alternatively, it can be provided, in particular in embodiments in which the separating strip extends over the entire cover plate and divides this into two halves, that no opening is provided.

In this embodiment too, a tongue can be provided which is connected to the separating strip. The tongue is designed as a radially extending extension which extends from the sheath of the cap. Accordingly, the tongue can be easily gripped by a user and the separating strip can be removed. If the user now pulls on the tongue, it removes the separating strip from the cap. The thin material points are broken open. The safety cap of the gas cylinder is therefore accessible on the one hand, and, on the other hand, it is also evident that the gas cylinder has already been opened.

A depression is preferably formed on the outer side of the sheath in order to provide the thin material point in the region of the sheath.

On the one hand, this allows simple manufacture, and on the other hand this also enables visual inspection with respect to the originality of the closure or the cap.

In order to provide the thin material point in the region of the cover plate, a depression is preferably formed on the inner side of the cover plate, at least in regions.

Such an arrangement makes it possible to create or maintain a pleasing appearance of the cover plate. In particular, it is possible to print or label the cover plate or to mark it with other elements.

By removing the separating strip, the upper part or the cover plate is separated, entirely or in part, into two parts and is no longer usable, since it is destroyed. The user can easily recognize whether the gas cylinder has already been used or not and can accordingly estimate whether or not a complete filling is still present in this gas cylinder.

In embodiments having a central opening, the tongue preferably covers the central opening to less than 40%. This ensures that the tongue can be gripped easily and without difficulty by the user.

The tongue can protrude over the cover plate. In other words, the tongue is formed as raised with respect to the cover plate. This facilitates the gripping of the tongue and the opening of the cap, or the tearing open of the thin material spot for separating the separating strip.

In all embodiments, a QR code can be arranged on the cover plate, in particular in the region of the Separating strip. Preferably, the QR code extends over the separating strip and in particular over the thin material points.

If the separating strip is separated or the material thin spot is broken open, the QR code is likewise destroyed.

By means of a correspondingly stored information in the QR code, the originality or the tamper evidence feature can additionally be secured. In particular, a destroyed QR code is no longer readable. This provides a simple means for testing for tampering.

At least one inwardly directed holding element can be arranged on the cap. This holding element makes it possible, with a given design of the safety cap, to engage with the safety cap. This makes it possible to guarantee a certain position of the cap with respect to the safety cap. In other words, the cap can be secured against twisting relative to the safety cap. The cap and the safety cap always have a defined position relative to one another.

This holding element can be connected to the cover plate. Such a connection increases the stiffness of the cap. As a result of a higher stiffness, material can be saved accordingly, since the strength does not have to be provided by other means.

Preferably, this holding element is designed as two spaced apart webs or surfaces. By means of such a design, a counterpart can be introduced between the two webs or surfaces and a rotation is thus prevented both in the clockwise direction and in the counterclockwise direction.

The invention is explained below with reference to schematic figures. These show:

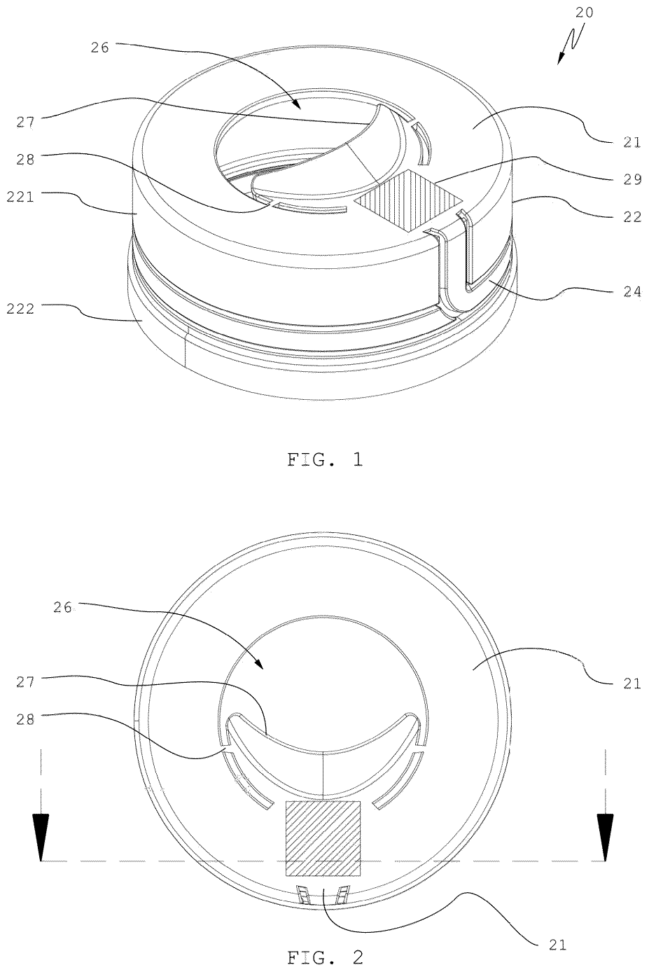

FIG. 1: shows a perspective view of a cap;

FIG. 2: shows a top view of the cap according to FIG. 1;

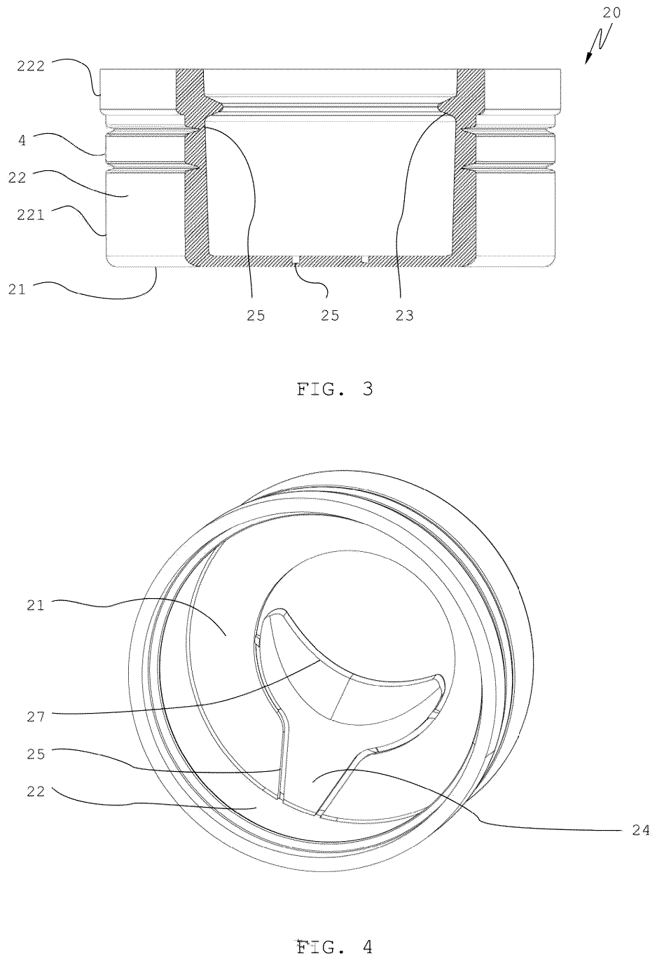

FIG. 3: shows a sectional view along the section line according to FIG. 2;

FIG. 4: shows a perspective view of the lower surfact of the cap according to FIG. 1;

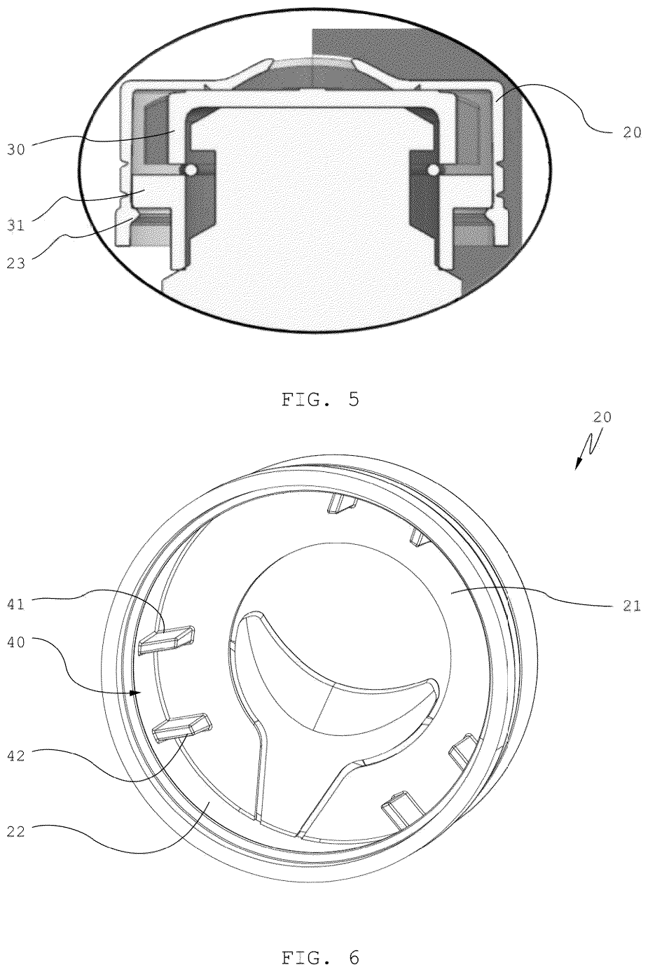

FIG. 5: shows a cross section through a cap placed on a gas bottle;

FIG. 6: shows a view analogous to the view according to FIG. 4 through an alternative cap;

FIG. 7: shows a further cross section through a cap placed on a gas cylinder.

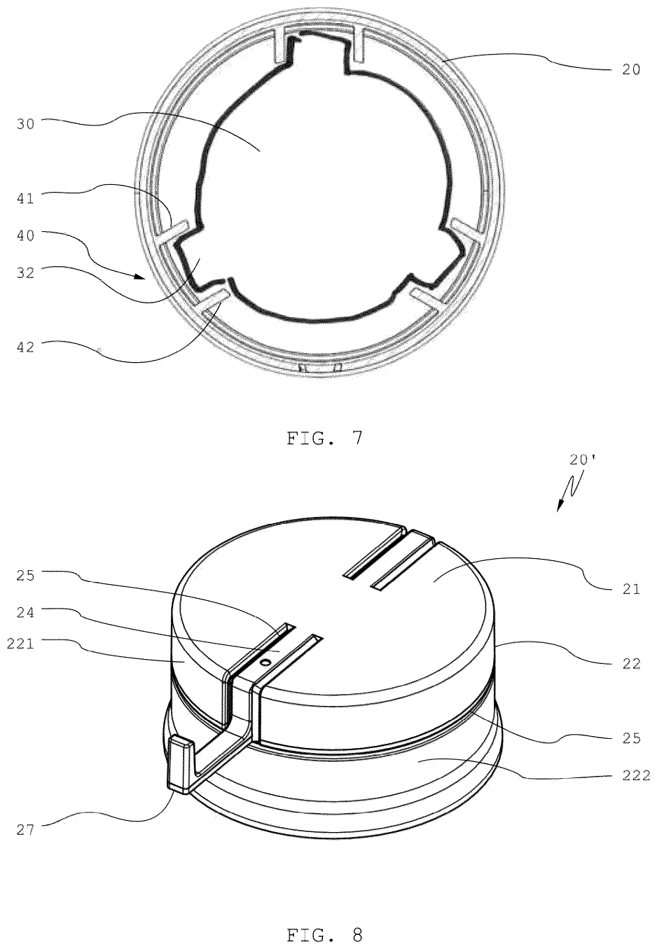

FIG. 8: shows a perspective view of a further cap;

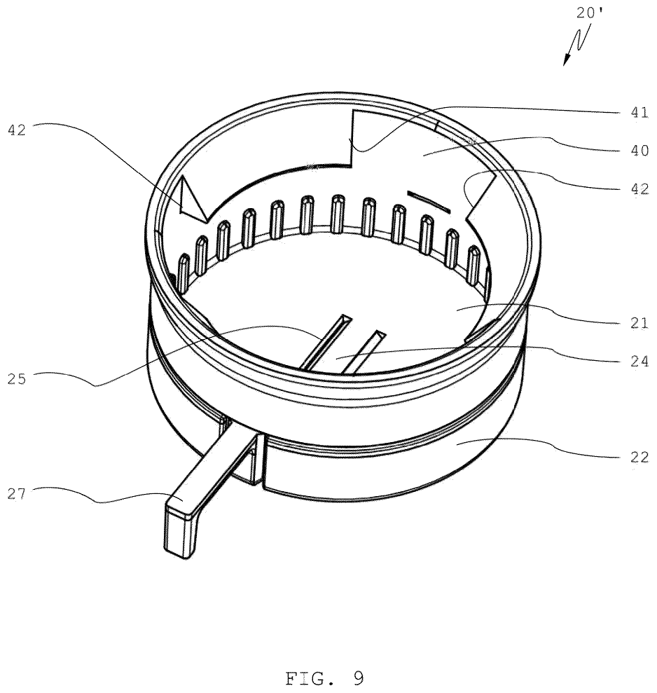

FIG. 9: shows a perspective view of the lower surface of the cap according to FIG. 8.

FIG. 1 shows a perspective view of a cap 20. The cap 20 has a cover plate 21 and a sheath 22. The sheath 22 is divided by a separating strip 24 into an upper part 221 and a safety ring 222. The separating strip 24 extends circumferentially on the periphery of the cap 20 via the sheath 22 into the cover plate 21. In the cover plate 21, the separating strip 24 extends into a central opening 26 of the cap 20. The separating strip 24 thus divides the cover plate 21 at least in regions into two halves. In this central opening 26, the separating strip 24 opens into a tongue 27. The tongue 27 is connected to the cover plate 21 via two material webs 28, of which only one is denoted for the sake of simplicity. As can be seen, a part of the tongue 27 is formed in such a manner that it can be gripped easily. A QR code 29 is formed in the region of the separating strip 24 on the cover plate 28. This is destroyed when separating or tearing off the separating strip 24.

FIG. 2 shows a plan view of the cap 20 according to FIG. 1. It is again apparent here that the tongue 27 is arranged centrally in the opening 26 and is connected to the cover plate 21 via the material webs 28. An intersection line which extends substantially through the separating strip 24 in the region of the cover is shown.

FIG. 3 shows the sectional view along the section line from FIG. 2. It can be seen that the sheath 22 is divided by the separating strip into an upper part 221 and a safety ring 222. The separating strip 24 is connected to the safety ring 222 or to the upper part 221 on both sides via a thin material point 25. An inwardly directed protrusion 23 is formed on the safety ring 222, for engagement in a corresponding counterpart on a safety cap of a gas cylinder (see FIG. 5). As can be seen, the thin material points in the region of the sheath 22 are formed in that two depressions are formed on the outside of the sheath 22. In contrast, in the region of the cover plate 21, the thin material point 25 is formed in that the depressions are formed on the inner side of the cover plate 21. The cover plate 21 thus retains a continuous and in particular printable surface to the outside.

FIG. 4 shows a perspective view of the lower surface of the cap 20 according to FIG. 1. It can be seen here that the thin material point is arranged on the outside in the region of the cover plate 21 and the thin material point in the area of the sheath 22. The external arrangement of the thin material point 25 in the region of the cover plate 21 also reduces the expenditure of force for opening or tearing off the separating strip 24 after the gripping of the tongue 27.

FIG. 5 shows a cross section through a cap 20 placed on a gas cylinder. As can be seen, the inwardly directed protrusion 23 engages around a corresponding protrusion 31 of a safety cap 30 which closes a connecting piece of a gas cylinder. The design as shown in the present case ensures that the cap 20 cannot be removed from the safety cap 30 without destruction.

FIG. 6 shows a view analogous to the view according to FIG. 4 through an alternative cap 20. This cap 20 has three retaining elements 40 on the inside of the sheath 22. The retaining elements 40 each have two inwardly directed webs 41 and 42. The webs 41 and 42 are spaced parallel to one another. For simplicity and for the sake of clarity, only one of the retaining elements 40 is provided with reference signs. The webs 41 and 42 are connected both to the sheath 22 and to the cover plate 21. This increases the rigidity of the cap 20. The function of these retaining elements 40 is described with reference to the following FIG. 7.

FIG. 7 shows a further cross section through a cap 20 placed on a gas cylinder, namely by a cap 20 as shown in FIG. 6. As can be seen, the retaining elements 40 and in particular the webs 41 and 42 each engage on both sides of an axial protrusion 32 of the safety cap 30, in such a manner that the cap 20 is secured against rotation relative to the safety cap 30.

FIG. 8 shows a perspective view of a further cap 20′. With regard to the function and the cooperation with a gas cylinder or a safety cap of a gas cylinder, reference is made to the description of the other figures. The cap 20′ also has a cover plate 21 and a sheath 22. The sheath 22 is divided by a thin material point 24 into an upper part 221 and a safety ring 222. A separating strip 24 ex-tends over the cover plate 21 and opens in a tongue 27, which is designed as a radial extension and extends from the periphery of the cap 20 over the sheath.

The circumferential thin material point 25 is connected to the thin material points on both sides of the separating strip 24. These thin material points are formed centrally in the cover plate 21 and on the outside at the edge of the cover plate 21.

The circumferential thin material point 25 is also arranged in such a way that the cover plate 21 and a portion of the sheath are connected to one another substantially with an uninterrupted wall thickness.

FIG. 9 shows a perspective view of the lower surface of the cap 20′ according to FIG. 8. It can be seen here that the thin material point is arranged on the inside in the central region of the cover plate 21 and on the outside on the periphery of the cover plate 21 and in the region of the sheath 22. The separating strip 24 extends into the tongue 27. The external arrangement of the thin material point 25 in the region of the cover plate 21 also reduces the expenditure of force for opening or tearing off the separating strip 24 after the gripping of the tongue 27.

This cap 20′ has a protrusion 23 on the inside of the sheath 22, which protrusion 23 is interrupted at three points. These three interruptions provide three holding elements 40. The holding elements 40 are delimited by two inwardly directed surfaces 41 and 42 in each case. The surfaces 41 and 42, analogous to the webs 41 and 42 from FIG. 6, are spaced apart parallel from one another. For simplicity and for the sake of clarity, only one of the retaining elements 40 is provided with reference signs. Since the holding elements 40 are provided by the protrusion 23, they have a high stiffness. The function of these holding elements 40 is analogous to the holding elements described with reference to FIG. 7.

The protrusion 23 has an insertion bevel, not designated in more detail, in order to be able to easily snap the cap 20′ onto a safety cap of a gas cylinder. This insertion bevel is compatible with all embodiments.

1. A cap (20) for providing a tamper evidence feature on a container, in particular on a gas container, the cap (20) having a cover plate (21) and a sheath (22) protruding therefrom, wherein a radially inwardly directed protrusion (23) is formed on the sheath (22), for engagement in a safety cap (30) of a gas cylinder, in particular for engagement under a protrusion (31) projecting radially from the safety cap (30), wherein a thin material point (25) is formed on the cap (20) and separates a separating strip (24) from the cap (20).

2. The cap (20) according to claim 1, wherein the separating strip (24) divides the cover plate (21) into two halves at least in regions, in particular completely.

3. The cap (20) according to claim 1, wherein the separating strip (24) divides the sheath (22) of the cap (20) into an upper part (221) and a safety ring (222).

4. The cap (20) according to claim 1, wherein a further material thin point is arranged circumferentially of the sheath (22) and divides the sheath (22) into an upper part (221) and a safety ring (222).

5. The cap (20) according to claim 3, wherein the protrusion (23) is arranged on the safety ring (222).

6. The cap (20) according to claim 1, wherein a substantially central opening (26) is arranged on the cover plate (21), wherein a tongue (27) is arranged within this opening (26), which tongue is connected to the separating strip (24).

7. The cap (20) according to claim 6, wherein the tongue (27) is connected to the cover plate (21) via two material webs (28).

8. The cap (20) according to claim 6, wherein the separating strip (24) is formed circumferentially on the periphery of the cap (20) and extends at its end over the sheath (22) into the cover plate (21) and opens into the tongue (27).

9. The cap (20) according to claim 6, wherein the tongue (27) covers the central opening (26) to less than 40%.

10. The cap (20) according to claim 6, wherein the tongue (27) protrudes beyond the cover plate (21).

11. The cap (20) according to claim 1, wherein a tongue (27) is connected to the separating strip (24), wherein said tongue (27) is designed as a radially extending extension which extends from the sheath (22) of the cap (20).

12. The cap (20) according to claim 1, wherein a depression is formed on the outer side of the sheath (25) in order to provide the thin material point (25) in the region of the sheath (22).

13. The cap (20) according to claim 1, wherein a depression is formed on the inner side of the cover plate (21) in order to provide the thin material point (25) in the region of the cover plate (21).

14. The cap (20) according to claim 1, wherein a QR code (29) is arranged on the cover plate (21), in particular in the region of the separating strip (24).

15. The cap (20) according to claim 14, wherein the QR code (29) extends over the thin material point (25).

16. The cap (20) according to claim 1, wherein at least one holding element facing towards the inside (40) is arranged on the cap (20).

17. The cap (20) according to claim 16, wherein said holding element (40) is connected to the cover plate (21).

18. The cap (20) according to claim 16, wherein said holding element (40) is designed as two spaced apart webs (41, 42).
